(19) United States
(12) Patent Application Publication
(10) Pub. No.: US 2009/0256829 A1
(43) Pub. Date: Oct. 15, 2009

(54) System and Method for Detecting a Sampling Frequency of an Analog Video Signal

(76) Inventors: Bing Ouyang, Plano, TX (US); John Michael Hayden, Allen, TX (US); Troy Lane Ethridge, Bedford, TX (US); Amit Mittal, Bangalore (IN); Jeffrey Kenneth Smith, McKinney, TX (US)

Correspondence Address: TEXAS INSTRUMENTS INCORPORATED, P O BOX 655474, M/S 3999, DALLAS, TX, 75265, US

(21) Appl. No.: 12/101,685

(22) Filed: Apr. 11, 2008

(51) Int. Cl. G09G 5/00; H04N 17/00

(52) U.S. Cl. 345/208; 348/180; 348/E17.001

(57) ABSTRACT

A system and method for detecting sampling frequency in a video signal. A method comprises applying a first test to determine the sampling frequency of the image signal, applying a second test to determine the sampling frequency of the image signal, and verifying the sampling frequency of the image signal. The first test compares detected timing characteristics of the image signal with known timing characteristics of a set of known standard image signals and the second test measures data characteristics of image data in the multiple image frames of the image signal. Combining both detected image characteristics and measured image characteristics based techniques to determine sampling frequency improves the possibility of correctly detecting an image signal's sampling frequency.

### TECHNICAL FIELD

The present invention relates generally to a system and method for displaying video and images, and more particularly to a system and method for detecting a sampling frequency of an analog video signal.

### BACKGROUND

In many modern video display systems, video frames of an analog video signal may be digitized prior to being displayed. The digitizing may include sampling the analog video signal without prior knowledge of a sampling frequency or sampling phase. Examples of analog video signals may include analog video, analog computer graphics, analog DVDs, analog game console output, and so forth. In general, the terms video and image may be used interchangeably.

Digitizing the video frames of the analog video signal may enable processing of video frames by processing hardware in the video display system. The processing by the processing hardware may be to improve image quality, reduce image noise, and so forth, for example. However, to properly digitize the video frames in the analog video signal, a sampling frequency of the video frames generally must be detected. If the sampling frequency of the analog video signal is incorrectly detected, then when the digitized images are displayed, the resulting images may be distorted at best or completely incomprehensible at worse.

FIG. 1a illustrates a video frame 100 from an analog video signal. The video frame 100 includes a circle 105 on a dark background 110. FIG. 1b illustrates a displayed video frame 150. The video frame 150 is representative of the video frame 100 sampled with an incorrect sampling frequency. The circle 105 from the video frame 100 has been distorted into an oval 155 in the video frame 150.

In general, there may be two different techniques used in the detection of the sampling frequency of video frames of an analog video signal. A first technique, commonly referred to as timing based detection of sampling frequency, may involve the measurement of synchronization signals or synchronization characteristics present in the analog video signal and then comparing the measured synchronization signals or synchronization characteristics with known video standard values to determine the sampling frequency of the analog video signal. The known video standard values may be stored in a memory, a table of some form, or a mathematical expression. An advantage of timing based detection of sampling frequency may be that the detection of sampling frequency may be achieved quickly; typically, the sampling frequency may be detected within several video frames.

A second technique, commonly referred to as data based detection of sampling frequency, may involve analysis of image content present in the analog video signal to determine the sampling frequency of the analog video signal. In general, data based detection of sampling frequency involves a detection of a left edge and a right edge of a video frame using frame data content detection techniques and then adjusting a sampling clock to determine the sampling frequency of the analog video signal. An advantage of data based detection of sampling frequency may be that the sampling frequency of a wide range of analog video signals may be detected, even when the sampling frequency of the analog video signals deviate from the sampling frequency of analog video signal of known video standards.

### SUMMARY OF THE INVENTION

These and other problems are generally solved or circumvented, and technical advantages are generally achieved, by embodiments of a system and a method for detecting a sampling frequency of an analog video signal.

In accordance with an embodiment, a method for determining a sampling frequency of an image signal having multiple image frames is provided. The method includes applying a first test to determine the sampling frequency of the image signal, applying a second test to determine the sampling frequency of the image signal, and verifying the sampling frequency of the image signal. The first test compares detected timing characteristics of the image signal with known timing characteristics of a set of known standard image signals, while the second test measures data characteristics of image data in the multiple image frames of the image signal.

In accordance with another embodiment, a method for displaying image frames of an image signal on a display system is provided. The method includes receiving the image signal, detecting a sampling frequency of image frames in the image signal, configuring the display system using the sampling frequency, and displaying the image frames. The detecting includes applying a first test to determine the sampling frequency, applying a second test to determine the sampling frequency, and verifying the sampling frequency. The first test compares detected timing characteristics of the image frames with standard timing characteristics of standard image frames adherent to an image standard and the second test measures data characteristics of image data contained in the image frames.

In accordance with another embodiment, a display system is provided. The display system includes a display that produces images by modulating light based on image data, an image input providing an image signal including the image data, and a controller electronically coupled to the display. The controller controls the operation of the display based on the image data. The controller includes a sampling frequency detect unit, the sampling frequency detect unit detects a sampling frequency of the image signal using both timing based sampling frequency detection and data based sampling frequency detection.

An advantage of an embodiment is that, in general, the detection of a sampling frequency for an analog video signal for a wider range of analog video signal types may be possible.

A further advantage of an embodiment is that the sampling frequencies of analog video signals that deviate from known video standards may also be detected. Furthermore, the ability to determine the sampling frequency of standard analog video sources when the image contains a black border or does not have significant high frequency content (i.e., black screen, solid color screen or color bar, etc.) may be improved.

Another advantage of an embodiment is that the capabilities of two different sampling frequency detection techniques may be exploited to obtain the performance advantages of both.

Yet another advantage of an embodiment is that the sampling frequency detection performance of both the timing based detection of sampling frequency and the data based detection of sampling frequency may be achieved without negatively impacting the overall sampling frequency detection performance.

The foregoing has outlined rather broadly the features and technical advantages of the present invention in order that the detailed description of the embodiments that follow may be better understood. Additional features and advantages of the embodiments will be described hereinafter which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the embodiments, and the advantages thereof, reference is now made to the following descriptions taken in conjunction with the accompanying drawings, in which:

FIG. 1a is a diagram of a video frame;

FIG. 1b is a diagram of a video frame displayed after being sampled with an incorrect sampling frequency;

FIG. 2a is a diagram of a video display system;

FIG. 2b is a diagram of a timing detect unit;

FIG. 3a is a diagram of an algorithm for use in detecting sampling frequency of a video signal;

FIG. 3b is a diagram of an algorithm for use in detecting sampling frequency of a video signal;

FIG. 4a is a diagram of a detailed view of detecting a sampling frequency of a video signal using a timing based sampling frequency detection technique;

FIG. 4b is a diagram of a detailed view of detecting a sampling frequency of a video signal using a data based sampling frequency detection technique and a verification of the detected sampling frequency;

FIG. 4c is a diagram of a detailed view of selecting a default sampling frequency; and

FIG. 5 is a diagram of a sequence of events in the displaying of video frames from a video signal.

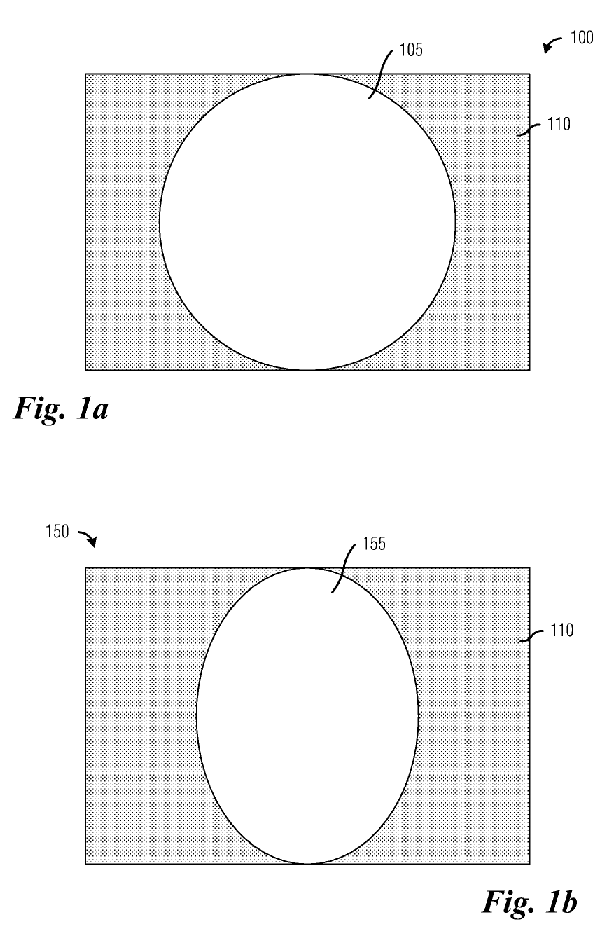

### DETAILED DESCRIPTION OF ILLUSTRATIVE EMBODIMENTS

The making and using of the embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The embodiments will be described in a specific context, namely a video display system having an analog video signal input, wherein the analog video signal may or may not be adherent to a Video Electronics Standards Association (VESA) video timing standard. The video display system is a projection display system that makes use of a microdisplay, namely a digital micromirror device (DMD), to display video. The invention may also be applied, however, to known video standards other than VESA, such as ad hoc standards, proprietary standards, and so forth. Furthermore, the invention may be applied to video display systems using other forms of microdisplays, such as deformable micromirrors, liquid crystal on silicon (LCOS), ferroelectric liquid-crystal-on-silicon, reflective, transmissive, and transflective liquid crystal displays (LCD), and so forth. Additionally, the invention may be applied to other types of video display systems, including direct view display systems, such as those using plasma, LCD, cathode ray tube (CRT), and so on, displays. In general, the invention may be applied to applications wherein there is a desire to detect a sampling frequency of an analog video signal, such as in security systems, video/image processing systems, and so forth.

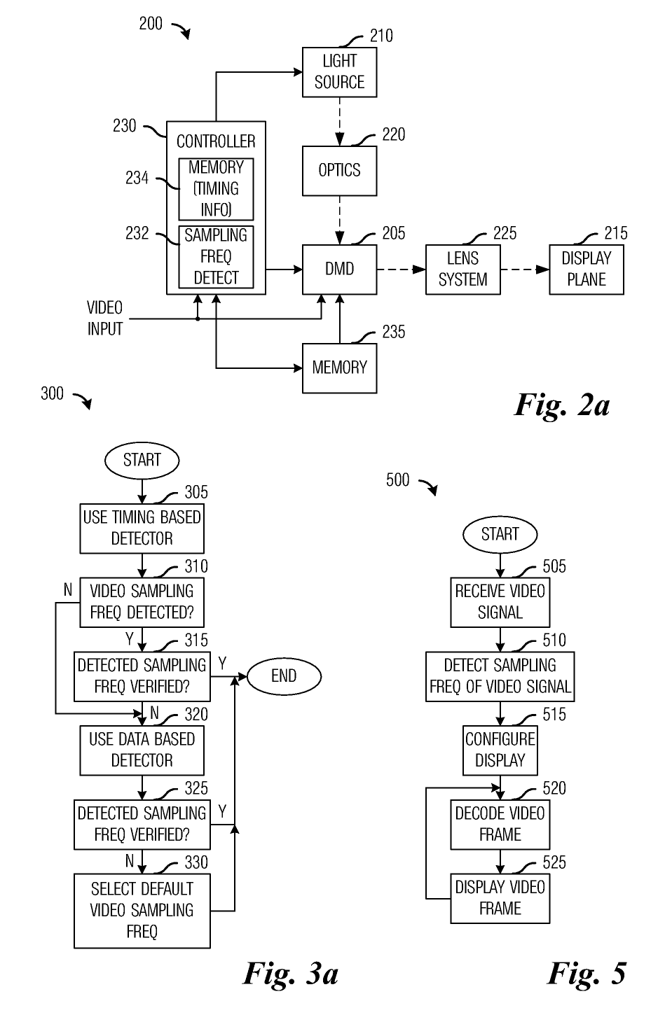

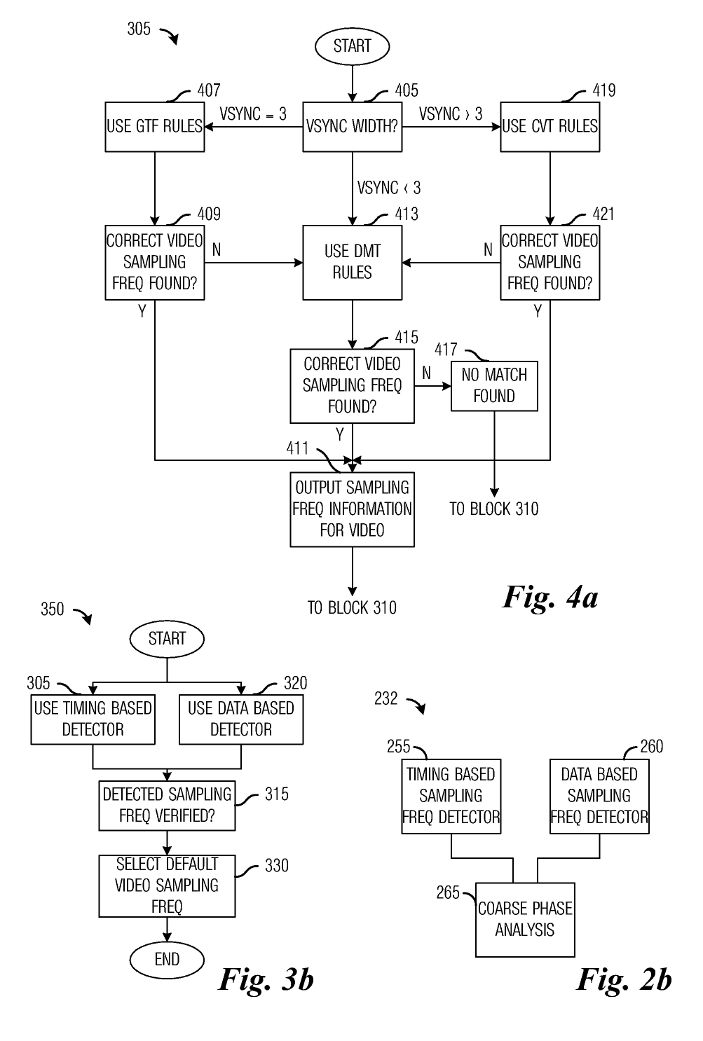

With reference now to FIG. 2a, there is shown a diagram illustrating a video display system 200. The video display system 200 includes a DMD 205 that modulates light produced by a light source 210. The DMD 205 is an example of a microdisplay or an array of light modulators. Other examples of microdisplays may include transmissive or reflective liquid crystal, liquid crystal on silicon, ferroelectric liquid-crystal-on-silicon, deformable micromirrors, and so forth. In a microdisplay, a number of light modulators may be arranged in a rectangular, square, diamond shaped, and so forth, array.

Each light modulator in the microdisplay may operate in conjunction with the other light modulators in the microdisplay to modulate the light produced by the light source 210. For example, in the DMD 205, each light modulator is a pivoting mirror that generally pivots between one of two positions depending on image data being displayed. In a first position, the light modulator reflects light from the light source onto a display plane 215 and in a second position, the light modulator reflects light away from the display plane 215. The light modulated by the DMD 205 may be used to create images on the display plane 215. The video projection display system 200 also includes an optics system 220, which may be used to collimate the light produced by the light source 210 as well as to collect stray light, and a lens system 225, which may be used to manipulate (for example, focus) the light reflecting off the DMD 205.

The DMD 205 may be coupled to a controller 230, which may be responsible for loading image data into the DMD 205, controlling the operation of the DMD 205, providing micromirror control commands to the DMD 205, controlling the light produced by the light source 210, and so forth. A memory 235, which may be coupled to the DMD 205 and the controller 230, may be used to store the image data, as well as configuration data, color correction data, and so forth.

The controller 230 includes a sampling frequency detect unit 232. The sampling frequency detect unit 232 may be a specially designed functional hardware unit, a state machine, a software application, or a combination thereof, in the controller 230. The sampling frequency detect unit 232 may be used to detect a sampling frequency required to accurately digitize video frames of an analog video signal provided by a video input. The analog video signal may be from a computer, a DVD, a high definition DVD, a video cassette player/recorder, a high definition video cassette player/recorder, a cable television or satellite television set top box (both standard and/or high definition), a wired or wireless multimedia server, a standard and/or high definition gaming console, and so forth, coupled to the video input of the video projection display system 200. The sampling frequency detect unit 232 may be capable of detecting the sampling frequency that may be required to accurately digitize the video frames of the analog video signal by utilizing both a timing based detection technique and a data based detection technique. By integrating (combining) both the timing based detection technique and the data based detection technique, advantages of both techniques may be gained.

The timing based detection technique may make use of timing information stored in a memory or a table. The timing information may be stored in the controller 230 in a memory 234. The memory 234 may be a general use memory or memory dedicated for the timing information. Alternatively, the timing information may be stored in the memory 235. Rather than timing information, the timing based detection technique may also make use of standard specified formulas and/or functions to compute sampling frequency. The data based detection technique processes the video frames of the analog video signal as it is received and may require scratch memory for processing purposes. The memory 235 or, if sufficient memory is available, the memory 234, may be used to meet memory requirements of the data based detection technique.

FIG. 2b illustrates a detailed view of the sampling frequency detect unit 232. The sampling frequency detect unit 232 includes a timing based sampling frequency detector unit 255 responsible for performing timing based sampling frequency detection. The sampling frequency detect unit 232 also includes a data based sampling frequency detection unit 260 responsible for performing data based sampling frequency detection. Both the timing based sampling frequency detector unit 255 and the data based sampling frequency detection unit 260 may be coupled to a coarse phase analysis unit 265. The coarse phase analysis unit 265 may be used to verify the sampling frequency determined by either the timing based sampling frequency detector unit 255 or the data based sampling frequency detection unit 260.

After either the timing based sampling frequency detector unit 255 or the data based sampling frequency detection unit 260 or both has determined a sampling frequency for the analog video signal, the coarse phase analysis unit 265 may be used to verify the correctness of the sampling frequency. For a detailed description of the operation of the coarse phase analysis unit 265, please refer to co-assigned U.S. Patent Application Number US 2006/0274207 A1, entitled “Method and Apparatus for Analog Graphics Sample Clock Frequency Verification,” published Dec. 7, 2006, which patent application is hereby incorporated herein by reference.

Although the discussion focuses on a video projection display system 200 using a DMD microdisplay, the embodiments may be applicable to video projection display systems using other forms of microdisplays, such as transmissive or reflective liquid crystal, liquid crystal on silicon, ferroelectric liquid-crystal-on-silicon, deformable micromirrors, and so forth. Additionally, the embodiments may be applicable to other types of display systems, including direct view display systems. Therefore, the discussion of a DMD-based video projection display system should not be construed as being limiting to either the spirit or the scope of the embodiments.

FIG. 3a illustrates a high-level view of an algorithm 300 for use in detecting a sampling frequency of an analog video signal. The algorithm 300 may execute in the sampling frequency detect unit 232 of the processor 230 of the video projection display system 200. The algorithm 300 may be executed when a video signal is initially detected at the video input of the video display system 200 or when a video signal already being received at the video display system 200 changes. Additionally, the algorithm 300 may be executed when a sampling frequency has not been successfully determined.

The sampling frequency detect unit 232 may begin the detecting of a sampling frequency of an analog video signal by using a timing based sampling frequency detection technique, such as implemented by the timing based sampling frequency detector unit 255 (block 305). The timing based sampling frequency detector unit 255 may operate by comparing measured synchronization signals or synchronization characteristics from video frames of the analog video signal with synchronization signals or synchronization characteristics of standard video formats, such as VESA video standard formats, to determine the sampling frequency of the analog video signal.

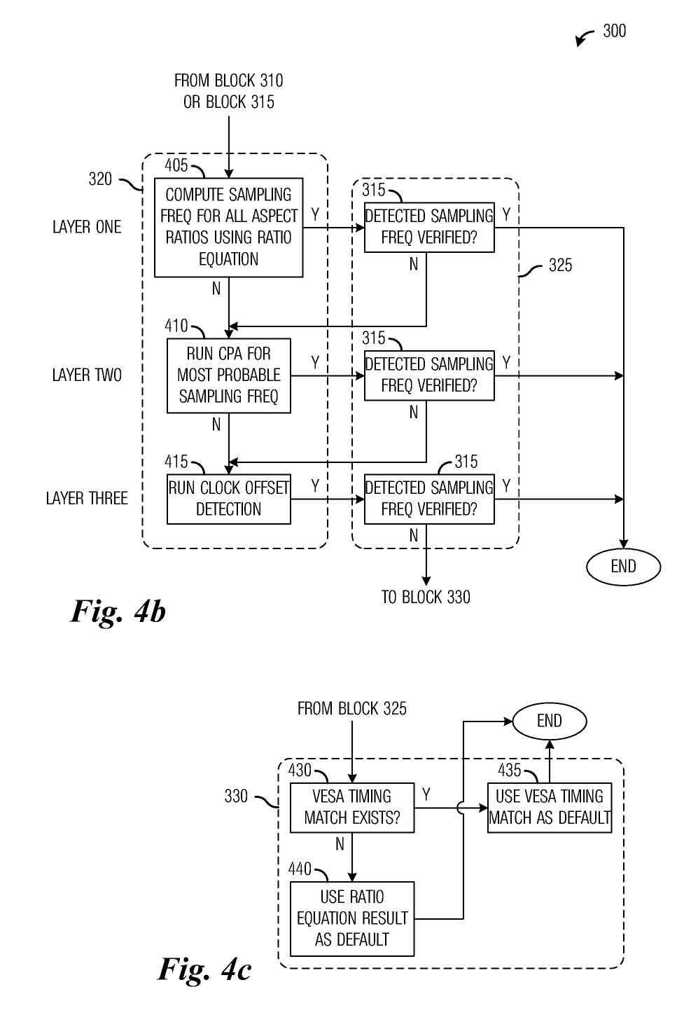

FIG. 4a illustrates a detailed view of the detecting a sampling frequency of an analog video signal using a timing based sampling frequency detection technique (block 305). The detecting of the sampling frequency of the analog video signal using the timing based sampling frequency detection technique may begin with a measurement of certain timing characteristics of video frames in the analog video signal, such as a width of a vertical synch pulse (VSYNC). The timing based sampling frequency detection technique may proceed using different approaches depending on the width of the VSYNC (block 405).

If the width of the VSYNC is substantially equal to three lines (such as horizontal lines, for example), then the timing based sampling frequency detection technique may use VESA's General Timing Formula (GTF) rules to determine the sampling frequency (block 407). The GTF rules are a standard method for generating general purpose display timings. The GTF rules are considered to be well understood by those of ordinary skill in the present embodiments and will not be discussed further herein.

After using VESA's GTF rules to determine sampling frequency, a check may be performed to determine if the correct video sampling frequency has been found using VESA's GTF rules (block 409). The check may be performed using the coarse phase analysis unit 265, for example. If the correct video sampling frequency has been found, then the video sampling frequency may be outputted and the timing based sampling frequency detection technique may be complete (block 411). If the correct video sampling frequency has not been found, then the timing based sampling frequency detection technique may use VESA's Display Monitor Timings (DMT) rules to determine the sampling frequency (block 413). The DMT rules provide the sampling frequency for a variety of computer displays. The DMT rules are considered to be well understood by those of ordinary skill in the present embodiments and will not be discussed further herein.

After using VESA's DMT rules to determine the sampling frequency, a check may be performed to determine if the correct sampling frequency has been found using VESA's DMT rules (block 415). The check may be performed using the coarse phase analysis unit 265, for example. If the sampling frequency has been found, then the video sampling frequency may be outputted and the timing based sampling frequency detection technique may be complete (block 411). If the correct video sampling frequency has not been found, then the timing based sampling frequency technique was not able to find a sampling frequency that matches the sampling frequency of the analog video signal (block 417) and the timing based sampling frequency technique has failed. The timing based sampling frequency technique may return an invalid value (or a null value) to indicate that it may have not been capable of find the correct sampling frequency.

If the width of the VSYNC is greater than three lines, then the timing based sampling frequency detection technique may use VESA's Coordinated Video Timings (CVT) rules to determine the sampling frequency (block 419). The CVT rules are a method for generating display timings for computer displays, including cathode ray tubes (CRT) and other display technologies. The CVT rules are considered to be well understood by those of ordinary skill in the present embodiments and will not be discussed further herein.

After using VESA's CVT rules to determine the sampling frequency, a check may be performed to determine if the correct video sampling frequency has been found using VESA's CVT rules (block 421). The check may be performed using the coarse phase analysis unit 265, for example. If the correct video sampling frequency has been found, then the video sampling frequency may be outputted and the timing based sampling frequency detection technique may be complete (block 411). If the correct video sampling frequency has not been found, then the timing based sampling frequency detection technique may use VESA's DMT rules to determine sampling frequency (block 413).

If the width of the VSYNC is less than three lines, then the timing based sampling frequency detection technique may use VESA's DMT rules (block 413). After applying the DMT rules (block 413), regardless if the DMT rules were the only rules used or if the GTF rules or the CVT rules failed to determine the sampling frequency for the analog video signal, a check may be performed to determine if the correct video sampling frequency has been found (block 415). The check may be performed using the coarse phase analysis unit 265, for example. If the correct sampling frequency has been found, then the video sampling frequency may be outputted and the timing based sampling frequency detection technique may be complete (block 411). If the correct video sampling frequency has not been found, then the timing based sampling frequency technique was not able to find a sampling frequency that matches the sampling frequency of the analog video signal (block 417) and the timing based sampling frequency technique has failed.

The detailed view of the timing based sampling frequency detection technique provided herein is based on a variety of VESA video standard formats. If different video formats are being detected, the timing based sampling frequency detection technique may differ. However, the general principle of detecting a sampling frequency for the analog video signal and comparing it with sampling frequency based on some standard video format remains valid.

The flow described above is just one possible embodiment of the timing based sampling frequency detection. As an alternative, checking against the three sets of rules may be performed in parallel. Then the resulting sampling frequencies (if any) may be checked for correctness. If a sampling frequency is verified for correctness, then the sampling frequency information may be outputted. If none of the sampling frequencies is verified for correctness, then failure of the timing based sampling frequency detection technique may be reported.

Turning back now to FIG. 3a, when the timing based sampling frequency detector unit 255 completes, a check may be performed to determine if the timing based sampling frequency detector unit 255 was able to detect a sampling frequency for the analog video signal (block 310). If a sampling frequency for the analog video signal was detected, then a check may be performed to verify if a sampling frequency of the analog video signal is correct (block 315). The verifying of the sampling frequency in block 315 may be a repeating of verifying of the sampling frequency to ensure that the sampling frequency is valid, since the timing based sampling frequency detector unit 255 may be capable of detecting a sampling frequency that may not pass verification. The verification of the sampling frequency of the analog video signal may be performed by the coarse phase analysis unit 265, for example. If the sampling frequency of the analog video signal has been verified, then the detecting of a sampling frequency of the analog video signal is complete and may terminate.

However, if the timing based sampling frequency detector unit 255 was not able to determine the sampling frequency of the analog video signal because the measured sampling frequency of the analog video signal did not match (or substantially match) any of the sampling frequencies stored in the memory 234 or if the detected sampling frequency did not verify for correctness, then the timing detect unit 232 may use a data based sampling frequency detection technique, such as implemented by the data based sampling frequency detector unit 260 (block 320). The data based sampling frequency detector unit 260 may operate by comparing data content on multiple video frames from the analog video signal and deriving a sampling frequency of the analog video signal from the data content.

FIG. 4b illustrates a detailed view of the detecting of a sampling frequency of an analog video signal using a data based sampling frequency detection technique (block 320) and a verification of the detected sampling frequency (block 325). In general, the data based sampling frequency detection technique measures data characteristics of video frames in the analog video signal. The operating of the data based sampling frequency detector unit 260 that may be used in the data based sampling frequency detection technique (block 320) may be partitioned into several layers.

A first layer in the operation of the data based sampling frequency detector unit 260 may involve a computation of sampling frequencies for the analog video signal using a variety of expected aspect ratios (block 405). The expected aspect ratios may be aspect ratios from VESA video standards, for example. The computation of sampling frequency may be performed using an equation, commonly referred to as a ratio equation, which expresses a relationship between an expected horizontal resolution and a sample clock to a difference between left and right edges (in terms of system clock) of a frame of the analog video signal and total system clock per line. The ratio equation may be expressible as:

$$\frac{Right edge - Left edge}{System clocks per line} = \frac{Expected horizontal resolution}{Sample clocks ( pixels ) per line} ,$$

where “Right edge” and “Left edge” are the right edge and the left edge of a frame of the analog video signal detected using frame data content detection, “System clocks per line” is a number of system clock cycles per horizontal line for a target video frame format, “Expected horizontal resolution” is an expected number of horizontal pixels per line for the target frame format, and “Sample clocks (pixels) per line” is a number of pixels per horizontal line derived from a sampling clock used to sample the analog video signal. The “System clocks per line” may be a number of system clock cycles per horizontal line derived from the internal clock of the controller 230, the sampling frequency detect unit 232, an Application Specific Integrated Circuit (ASIC), or so forth. The “Expected horizontal resolution” may be based on an aspect ratio of frames in the analog video signal and may be a known value (for example, based on VESA video standards), while the “Right edge,” the “Left edge,” the “System clocks per line” and the “Sample clocks (pixels) per line” may be based on frame data content and the sampling clock.

The ratio equation may be solved for the “Sample clocks (pixels) per line” for the expected aspect ratios of video frames in the analog video signal and the sampling frequency for the analog video signal may be selected from the solution of the ratio equation that best fits the analog video signal. After selecting the sampling frequency from the solution of the ratio equation, the selected sampling frequency may be verified in block 325, wherein the verification may be performed by the coarse phase analysis unit 265. An implementation of the verification of the selected sampling frequency in block 325 may be similar to the verification of the sampling frequency of the analog video signal in block 315.

If the first layer of operation of the data based sampling frequency detection unit 260 (block 405) was not able to detect the sampling frequency of the analog video signal, the data based sampling frequency detection unit 260 may move to a second layer of operation. The second layer of operation may entail a running of a coarse phase analysis algorithm, such as implemented by the coarse phase analysis unit 265, for a set of probable sampling frequencies (block 410). The set of probable sampling frequencies includes a variety of display resolutions and aspect ratios. The coarse phase analysis algorithm may test each of the probable sampling frequencies against the analog video signal to determine if one of the probable sampling frequencies is a good match for the analog video signal. For a detailed discussion of the coarse phase analysis algorithm, please refer to co-assigned U.S. Patent Application Number US 2006/0274194 A1, entitled “Method and Apparatus for Analog Graphics Sample Clock Frequency Offset Detection and Verification,” published Dec. 7, 2006, which patent application is hereby incorporated herein by reference.

If the second layer of operation of the data based sampling frequency detection unit 260 (block 410) was not able to detect the sampling frequency of the analog video signal, the data based sampling frequency detection unit 260 may move to a third layer of operation. The third layer of operation may entail a running of a clock offset detection algorithm (block 415). The clock offset detection algorithm makes use of a periodic pattern in an error count data that arises when there is a difference (clock_offset) between a sampling clock (current_clock) used to process the analog video signal and an actual clock of the analog video signal. The period of the periodic pattern, Tₑᵣᵣₒᵣ_{_{—}}_{count}, may be related to the clock offset by an equation expressible as:

$$clock\_offset = current\_clock ( \frac{1}{{T}_{error\_count}} ) .$$

The relationship may then be used to adjust the sampling clock (current_clock). The sampling frequency may then be derived from the sampling clock. For a detailed description of the clock offset detection algorithm, please refer again to co-assigned U.S. Patent Application Number US 2006/0274194 A1, entitled “Method and Apparatus for Analog Graphics Sample Clock Frequency Offset Detection and Verification,” published Dec. 7, 2006.

Turning back now to FIG. 3a, when one of the layers of the data based sampling frequency detector unit 260 completes or the data based sampling frequency detector unit 260 completes, a check may be performed to verify the correctness of the sampling frequency of the analog video signal (block 325). The check to verify the detected sampling frequency of the analog signal in block 320 may use the coarse phase analysis algorithm, for example. If the sampling frequency of the analog video signal has been verified, then the detecting of a sampling frequency of the analog video signal is complete and may terminate.

If the data based sampling frequency detector unit 260 was not able to determine the sampling frequency of the analog video signal or if the verification of the detected sampling frequency of the analog clock signal failed, then the timing detect unit 232 may select a default sampling frequency for the analog video signal (block 330). The default sampling frequency may be a fail-safe sampling frequency that may most likely enable the displaying of a viewable image from the analog video signal. The displayed image using the default sampling frequency may have lower image quality than if the analog video signal's actual sampling frequency were used, but the use of the default sampling frequency may result in an acceptable image.

FIG. 4c illustrates a detailed view of the selecting of a default sampling frequency for the analog video signal (block 330). A check may be made to determine if a VESA sampling frequency match exists (block 430). Although the VESA sampling frequency match exists, the VESA sampling frequency match may have failed verification in block 315 and was rejected, for example. If the VESA sampling frequency match does exist, then the VESA sampling frequency match may be used as the default sampling frequency (block 435). If the VESA sampling frequency match does not exist, then a sampling frequency match (or closest match) from the use of the ratio equation for a default aspect ratio (block 405) may be used as the default sampling frequency (block 440). With the default sampling frequency selected, the detecting of a sampling frequency of the analog video signal is complete and may terminate.

Turning back now to FIG. 3a, although the algorithm 300 illustrates the use of the timing based sampling frequency detection technique prior to the use of the data based sampling frequency detection technique, it may be preferred that the data based sampling frequency detection technique be used before the timing based sampling frequency detection technique is used. Alternatively, it may be possible that the two techniques be used simultaneously, with the timing based sampling frequency detector unit 255 and the data based sampling frequency detector unit 260 being used in parallel. Therefore, the discussion of the use of timing based sampling frequency detection technique prior to the use of the data based sampling frequency detection technique should not be construed as being limiting to either the scope or the spirit of the embodiments.

FIG. 3b illustrates a high-level view of an algorithm 350 for use in detecting a sampling frequency of an analog video signal. The detecting of a sampling frequency of an analog video signal shown in the algorithm 350 features a parallel or substantially parallel execution of the timing based sampling frequency detection technique (block 305) and the data based sampling frequency detection technique (block 320). The results of both the timing based sampling frequency detection technique (block 305) and the data based sampling frequency detection technique (block 320) may then be verified (block 315). The verification may be performed using the coarse phase analysis unit 265, for example. If neither the timing based sampling frequency detection technique (block 305) nor the data based sampling frequency detection technique (block 320) was able to select a verifiable sampling frequency, then a default video sampling frequency may be selected (block 330).

FIG. 5 illustrates a sequence of events 500 in the displaying of video frames from a video signal on a display system. The sequence of events 500 may be descriptive of events taking place in a video display system, such as the video display system 200, with a controller, such as the controller 230, of the video display system 200 regulating the sequence of events 500.

The controller 230 may initiate the sequence of events 500 when it detects that a video signal is being received at the video input of the video display system 200 (block 505). The video signal may be a new video signal or it may be a video signal that is currently received but the sampling frequency of the video signal has changed. Alternatively, the video signal may be currently received by the video display system 200, but the video display system 200 has not been able to determine a sampling frequency for the video signal.

The controller 230 may then attempt to detect a sampling frequency of the video signal (block 5 10). The controller 230 may utilize a multiple technique approach to detect the sampling frequency of the video signal, such as the timing based sampling frequency detection technique and the data based sampling frequency detection technique illustrated in the algorithm 300 shown in FIG. 3a or the algorithm 350 shown in FIG. 3b. The algorithm 300 may execute in a sampling frequency detect unit, such as the sampling frequency detect unit 232, of the processor 230.

After the controller 230 detects the sampling frequency of the video signal, either through the timing based sampling frequency detection technique or the data based sampling frequency detection technique or by using a default sampling frequency, the controller 230 may then configure the video display system 200 to display video frames from the video signal (block 515). The controller 230 may configure the video display system 200 by providing information to set up the video display system 200 to display video frames from the video signal. The information may include a number of lines per video frame, horizontal line time, synchronization signal polarity, vertical synchronization signal width, and so forth.

With the video display system 200 configured, the video frames may be displayed. The displaying of the video frames may include decoding video frames from the video signal (block 520) and then the decoded video frames may be displayed (block 525). The displaying of the video frames may continue until the video signal at the video input stops, the video display system 200 is turned off, enters a sleep or suspend mode, reset, or so forth.

Although the embodiments and their advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for determining a sampling frequency of an image signal having multiple image frames, the method comprising:
applying a first test to determine the sampling frequency of the image signal, wherein the first test compares detected timing characteristics of the image signal with known timing characteristics of a set of known standard image signals;
applying a second test to determine the sampling frequency of the image signal, wherein the second test measures data characteristics of image data in the multiple image frames of the image signal; and
verifying the sampling frequency of the image signal.

2. The method of claim 1 further comprising, after the verifying the sampling frequency, using a default sampling frequency in response to a determining that the verifying the sampling frequency has failed.

3. The method of claim 2, wherein the default sampling frequency is the sampling frequency determined by the first test.

4. The method of claim 2, wherein the default sampling frequency is the sampling frequency determined by the second test, wherein the measured data characteristics correspond to a default aspect ratio.

5. The method of claim 1, wherein the applying the first test comprises:
detecting the timing characteristics of the image signal; and
selecting the sampling frequency of one of the standard image signals in response to a determining that the known timing characteristics of the one standard image signal substantially match the detected timing characteristics of the image signal.

6. The method of claim 5, wherein the applying the first test further comprises selecting a fail-safe value in response to a determining that the detected timing characteristics do not substantially match the timing characteristics of any image signal in the set of known standard image signals.

7. The method of claim 5, wherein the applying the first test further comprises, after the detecting timing characteristics, applying a set of image standard rules to the detected timing characteristics.

8. The method of claim 1, wherein the applying the second test comprises:
computing a database of data characteristics for the image signal with each aspect ratio in a set of aspect ratios; and
selecting the sampling frequency corresponding to an aspect ratio in the set of aspect ratios having data characteristics that substantially match the measured data characteristics.

9. The method of claim 8, wherein the computing the database of data characteristics comprises applying a ratio equation to the each aspect ratio in the set of aspect ratios, wherein the ratio equation is expressible as:
$$\frac{Right edge - Left edge}{System clocks per line} = \frac{Expected horizontal resolution}{Sample clocks ( pixels ) per line} ,$$
where “Right edge” is a measured right edge of an image frame in the image signal, “Left edge” is a measured left edge of the image frame in the image signal, “System clocks per line” is a number of system clock cycles per horizontal line for an aspect ratio in the set of aspect ratios, “Expected horizontal resolution” is an expected number of horizontal pixels per line for an aspect ratio in the set of aspect ratios, and “Sample clocks (pixels) per line” is a measured number of pixels per horizontal line based on a sampling clock used to sample the image signal.

10. The method of claim 8, wherein the applying the second test further comprises:
computing probable data characteristics for each probable sampling frequency in a set of probable sampling frequencies; and
selecting the sampling frequency corresponding to a probable sampling frequency in the set of probable sampling frequency having probable data characteristics that substantially match the measured data characteristics.

11. The method of claim 10, wherein the applying the second test signal further comprises executing a clock offset detection algorithm.

12. The method of claim 11, wherein the clock offset detection algorithm comprises adjusting a sampling clock to maximize an error count period between frame data in image frames in the image signal.

13. The method of claim 1, wherein the applying the first test and the applying the second test are performed substantially in parallel.

14. A method for displaying image frames of an image signal on a display system, the method comprising:
receiving the image signal;
detecting a sampling frequency of image frames in the image signal, wherein the detecting comprises
applying a first test to determine the sampling frequency, wherein the first test compares detected timing characteristics of the image frames with standard timing characteristics of standard image frames adherent to an image standard,
applying a second test to determine the sampling frequency, wherein the second test measures data characteristics of image data contained in the image frames, and
verifying the sampling frequency;
configuring the display system using the sampling frequency; and
displaying the image frames.

15. The method of claim 14, wherein the applying the first test comprises:
detecting timing characteristics of the image signal;
computing detected timing characteristics from the timing characteristics and each image rule in a set of image rules as specified by the image standard; and
selecting the sampling frequency corresponding to standard timing characteristics in response to a determining that the standard timing characteristics substantially match the detected timing characteristics.

16. The method of claim 14, wherein the first test and the second test are performed in parallel.

17. The method of claim 14, wherein the detecting the sampling frequency of image frames further comprises using a default sampling frequency in response to a determining that the verifying the sampling frequency failed.

18. A display system comprising:
a display configured to produce images by modulating light based on image data;
an image input providing an image signal comprising the image data; and
a controller electronically coupled to the display, the controller configured to control the operation of the display based on the image data, the controller comprising a sampling frequency detect unit, the sampling frequency detect unit configured to detect a sampling frequency of the image signal using both timing based sampling frequency detection and data based sampling frequency detection.

19. The display system of claim 18, wherein the sampling frequency detect unit comprises:
a timing based sampling frequency detector configured to detect the sampling frequency of the image signal by comparing detected timing characteristics of the image signal with known timing characteristics of known standard image signals;
a data based sampling frequency detector configured to compute the sampling frequency of the image signal using the image data from multiple image frames in the image signal; and
an analysis unit coupled to the timing based sampling frequency detector and to the data based sampling frequency detector, the analysis unit configured to verify the sampling frequency detected by the timing based sampling frequency detector or computed by the data based sampling frequency detector.

20. The display system of claim 19, wherein the analysis unit further is configured to compute image characteristics of each probable sampling frequency in a set of probable sampling frequencies.
